(19) United States
(12) Patent Application Publication
(10) Pub. No.: US 2008/0097848 A1
(43) Pub. Date: Apr. 24, 2008

(54) Day Part Frame Criteria

(76) Inventors: Patrick Julien, Mascouche (CA); Bryan Mongeau, Montreal (CA); Daniel Parisien, Montreal (CA)

Correspondence Address: TECHNOLOGY LAW GROUP, LLC, 2215 West State Street, BOISE, ID, 83702, US

(21) Appl. No.: 11/828,164

(22) Filed: Jul. 25, 2007

Related U.S. Application Data
(60) Provisional application No. 60/820,589, filed on Jul. 27, 2006.
(60) Provisional application No. 60/820,591, filed on Jul. 27, 2006.
(60) Provisional application No. 60/820,594, filed on Jul. 27, 2006.
(60) Provisional application No. 60/820,595, filed on Jul. 27, 2006.
(60) Provisional application No. 60/820,598, filed on Jul. 27, 2006.

(51) Int. Cl. G06Q 30/00

(52) U.S. Cl. 705/14

(57) ABSTRACT

A system and method for distributing target advertising content to various electronic displays in a network of electronic displays. The invention discloses the technique of partitioning the electronic displays, partitioned both by geography and time, and providing an associated loop policy and frame criteria rules for each frame. The loop policy specifies a time period for repeating advertising content, and can optionally allow loop undersaturation and loop oversaturation for particular advertising messages. Frame criteria rules are disclosed that identify and describe allowable conditions that must be satisfied before a message is displayed, thus allowing advertisements, inappropriate for a particular frame at a particular time to be blocked.

### CROSS-REFERENCE TO RELATED APPLICATIONS

This application claims priority under 35 U.S.C. §119(e) to U.S. Provisional Application No. 60/820,589, filed Jul. 27, 2006, entitled “Network Control Time Spans,” U.S. Provisional Application No. 60/820,591, filed Jul. 27, 2006, entitled “Broadcast Day,” U.S. Provisional Application No. 60/820,594, filed Jul. 27, 2006, entitled “Campaign Performance Report,” U.S. Provisional Application No. 60/820,595, filed Jul. 27, 2006, entitled “Day Part Frame Criteria,” and U.S. Provisional Application No. 60/820,598, filed Jul. 27, 2006, entitled “Fine-Grained Criteria Targeting,” the entire contents of each are hereby incorporated by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention relates to enhancements to a digital signage system. More particularly, the invention relates to a system and method of a more efficient system of automating and managing the administration of a network of digital signs by associating a construct called a “day part” with a display unit or a frame of a display unit to provide for different behavior at different times.

### BRIEF SUMMARY OF THE INVENTION

The present invention provides for a digital signage system that directs directing advertising content, targeted for a specific audience, to appropriate electronic displays at appropriate times. The invention provides that each electronic display in a network is logically split into one or more frames, where each frame represents a fraction of the electronic display real estate for a particular interval of time, typically part of a day, and are thus sometimes referred to as “day parts”. For instance, a movie theater may split the screen into two frames, one which loops advertisements and the other showing the showtime schedule and prices.

Each frame has its own set of frame criteria rules that determine operating procedures for that frame. The frame criteria rules identify allow conditions that must be met before an advertisement will be displayed. Frame criteria rules typically include operating hours, and loop policy information, the latter dictates the length in time of a repeating block of advertising messages. Frame criteria rules can include criteria describing advertising content deemed appropriate for the particular display, and thus facilitate targeting an appropriate subset of frames within a network that are appropriate for a particular advertising campaign. Messages for a particular display are typically grouped into a message block, and a typical advertising message block contains one occurrence of each message for each loop. This invention further provides for exceptional cases of loop oversaturation where a particular message can be repeated within a single loop more than once if appropriate. The invention further provides for loop undersaturation where a message is displayed less often than once per loop, such as being displayed only every second or third loop iteration. The invention protects the loop duration time even in the presence of loop undersaturation and loop oversaturation to preserve scheduling benefits that come from having a fixed length loop duration.

The invention also provides that frames can be assigned a meaningful textual label that reflects the location of the containing electronic display or other semantic information to aid in locating frames appropriate for particular content.

### BRIEF DESCRIPTION OF SEVERAL VIEWS OF THE DRAWINGS

FIG. 1 is a block diagram showing generally the basic features of the invention.

### DETAILED DESCRIPTION OF THE INVENTION

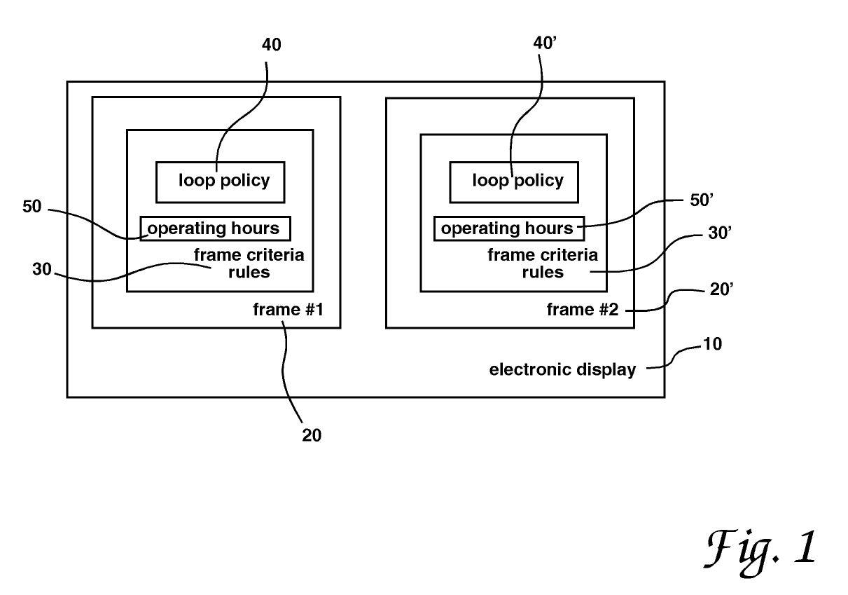

The present invention significantly advances the prior art by providing for a system and method to enhance digital signage systems. FIG. 1 illustrates an electronic display having multiple display frames 20 and 20′. Each frame has its own criteria rules, and thus, with respect to content and scheduling operations, can operate independently from other frames 20 including other frames 20 on the same electronic display unit 10. Frame criteria rules can contain any appropriate criteria to help decide what content to display and when to display it. Frame criteria rules 30 typically include a loop policy 40 to govern how often and under what circumstances advertising content is repeated at the associated frame 20. Often frame criteria rules 30 reflect the anticipated demographics at a particular location. For this reason, frame criteria rules often include a schedule that reflects the operating hours 50 for the given frame.

In one embodiment, multiple frames can be defined that identify the same physical display frame location, but have different operating hours. In this configuration, the frame 20 and its related operating hours 50 and related criteria 30 are sometimes called day parts to reflect that each logical frame represents a particular time of day and can be configured to accommodate expected viewing traffic at a particular time. For example, for a frame 20 housed in an electronic display 10 located in a retail establishment near a school, multiple day parts could be designed for the same physical display frame to present advertising content appropriate for students at times the students are not expected to be in school, and provide different advertising criteria at other times directed at non-students.

Each frame 20 also includes and independent loop policy 40, that controls how often content is repeated. The loop policy 40 generally reflects both anticipated traffic patterns and the requirements imposed by the various advertising campaign deployed at a particular location.

The present invention provides for loop policies that support both oversaturation and undersaturation. Loop policies typically are assigned a duration over which content is generally repeated. For example, a loop policy 40 may have an assigned duration of 40 minutes, meaning content is generally repeated every 40 minutes. Having a constant assigned duration greatly assists in the flexibility of scheduling. Unfortunately, other constraints, for example business constraints, may make it desirable for whatever reason to either have an advertisement repeat more than once per loop cycle (loop oversaturation) or, to the contrary, have an ad appear less often than once per loop (loop undersaturation), for example, once every three loop. This provides the unique benefit, among others, of maintain a loop duration fixed in time for scheduling purposes, yet accommodating special needs as exceptions without requiring the exceptions to corrupt the loop duration.

This description is provided for the purposes of illustration, not limitation. As one skilled in the art will appreciate, there are a number of alternate embodiments of the present invention not shown, that are in the spirit of the invention. The invention is only limited by the claims as set forth below

We claim:

1. A system for distributing targeted advertising content within a network of electronic displays comprising:
a message frame, said message frame further includes frame criteria rules that identify allowable conditions for said message frame to display said targeted advertising content,
wherein said targeted advertising content is displayed on said message frame only if the allowable conditions are satisfied.

2. The system of claim 1, wherein the message frame further includes a frame layout, the frame layout identifies the display location of the frame on at least one electronic display.

3. The system of claim 2, wherein said message frame further includes a frame label, wherein message frame is referenced by the frame label.

4. The system of claim 3, wherein said frame criteria rules include rules that govern the operating hours of said message frame.

5. The system of claim 4, wherein said frame criteria rules further include a loop policy, wherein the loop policy identifies conditions suitable for repeating said targeted advertising content on said frame.

6. The system of claim 5, wherein said loop policy further includes an associated duration, a loop oversaturation means and a loop undersaturation means.

7. The system of claim 3, wherein said frame criteria rules further include a loop policy, wherein the loop policy identifies conditions suitable for repeating said targeted advertising content on said frame.

8. The system of claim 7, wherein said loop policy further includes an associated duration, a loop oversaturation means and a loop undersaturation means.

9. The system of claim 2, wherein said frame criteria rules include rules that govern the operating hours of said message frame.

10. The system of claim 9, wherein said frame criteria rules further include a loop policy, wherein the loop policy identifies conditions suitable for repeating said targeted advertising content on said frame.

11. The system of claim 10, wherein said loop policy further includes an associated duration, a loop oversaturation means and a loop undersaturation means.

12. The system of claim 2, wherein said frame criteria rules further include a loop policy, wherein the loop policy identifies conditions suitable for repeating said targeted advertising content on said frame.

13. The system of claim 12, wherein said loop policy further includes an associated duration, a loop oversaturation means and a loop undersaturation means.

14. The system of claim 1, wherein said message frame further includes a frame label, wherein message frame is referenced by the frame label.

15. The system of claim 14, wherein said frame criteria rules include rules that govern the operating hours of said message frame.

16. The system of claim 15, wherein said frame criteria rules further include a loop policy, wherein the loop policy identifies conditions suitable for repeating said targeted advertising content on said frame.

17. The system of claim 16, wherein said loop policy further includes an associated duration, a loop oversaturation means and a loop undersaturation means.

18. The system of claim 14, wherein said frame criteria rules further include a loop policy, wherein the loop policy identifies conditions suitable for repeating said targeted advertising content on said frame.

19. The system of claim 18, wherein said loop policy further includes an associated duration, a loop oversaturation means and a loop undersaturation means.

20. The system of claim 1, wherein said frame criteria rules include rules that govern the operating hours of said message frame.

21. The system of claim 20, wherein said frame criteria rules further include a loop policy, wherein the loop policy identifies conditions suitable for repeating said targeted advertising content on said frame.

22. The system of claim 21, wherein said loop policy further includes an associated duration, a loop oversaturation means and a loop undersaturation means.

23. The system of claim 1, wherein said frame criteria rules further include a loop policy, wherein the loop policy identifies conditions suitable for repeating said targeted advertising content on said frame.

24. The system of claim 23, wherein said loop policy further includes an associated duration, a loop oversaturation means and a loop undersaturation means.

25. A method for distributing targeted advertising content within a network of electronic displays comprising the steps of:
associating a message frame with each electronic display, said message frame further includes frame criteria rules that identify allowable conditions for said message frame to display said targeted advertising content,
wherein said targeted advertising content is displayed on said message frame only if the allowable conditions are satisfied.

26. The method of claim 25, wherein the message frame further includes a frame layout, the frame layout identifies the display location of the frame on at least one electronic display.

27. The method of claim 26, wherein said message frame further includes a frame label, wherein message frame is referenced by the frame label.

28. The method of claim 27, wherein said frame criteria rules include rules that govern the operating hours of said message frame.

29. The method of claim 28, wherein said frame criteria rules further include a loop policy, wherein the loop policy identifies conditions suitable for repeating said targeted advertising content on said frame.

30. The method of claim 29, wherein said loop policy further includes an associated duration, a loop oversaturation means and a loop undersaturation means.

31. The method of claim 27, wherein said frame criteria rules further include a loop policy, wherein the loop policy identifies conditions suitable for repeating said targeted advertising content on said frame.

32. The method of claim 31, wherein said loop policy further includes an associated duration, a loop oversaturation means and a loop undersaturation means.

33. The method of claim 26, wherein said frame criteria rules include rules that govern the operating hours of said message frame.

34. The method of claim 33, wherein said frame criteria rules further include a loop policy, wherein the loop policy identifies conditions suitable for repeating said targeted advertising content on said frame.

35. The method of claim 34, wherein said loop policy further includes an associated duration, a loop oversaturation means and a loop undersaturation means.

36. The method of claim 26, wherein said frame criteria rules further include a loop policy, wherein the loop policy identifies conditions suitable for repeating said targeted advertising content on said frame.

37. The method of claim 36, wherein said loop policy further includes an associated duration, a loop oversaturation means and a loop undersaturation means.

38. The method of claim 25, wherein said message frame further includes a frame label, wherein message frame is referenced by the frame label.

39. The method of claim 38, wherein said frame criteria rules include rules that govern the operating hours of said message frame.

40. The method of claim 39, wherein said frame criteria rules further include a loop policy, wherein the loop policy identifies conditions suitable for repeating said targeted advertising content on said frame.

41. The method of claim 40, wherein said loop policy further includes an associated duration, a loop oversaturation means and a loop undersaturation means.

42. The method of claim 38, wherein said frame criteria rules further include a loop policy, wherein the loop policy identifies conditions suitable for repeating said targeted advertising content on said frame.

43. The method of claim 42, wherein said loop policy further includes an associated duration, a loop oversaturation means and a loop undersaturation means.

44. The method of claim 25, wherein said frame criteria rules include rules that govern the operating hours of said message frame.

45. The method of claim 44, wherein said frame criteria rules further include a loop policy, wherein the loop policy identifies conditions suitable for repeating said targeted advertising content on said frame.

46. The method of claim 45, wherein said loop policy further includes an associated duration, a loop oversaturation means and a loop undersaturation means.

47. The method of claim 25, wherein said frame criteria rules further include a loop policy, wherein the loop policy identifies conditions suitable for repeating said targeted advertising content on said frame.

48. The method of claim 47, wherein said loop policy further includes an associated duration, a loop oversaturation means and a loop undersaturation means.
